(19) United States
(12) Patent Application Publication
(10) Pub. No.: US 2008/0252132 A1
(43) Pub. Date: Oct. 16, 2008

(54) Vehicle Safety Device

(76) Inventor: Hugh Thomson, Lanarkshire (GB)

Correspondence Address: RATNERPRESTIA, P O BOX 980, VALLEY FORGE, PA, 19482-0980, US

(21) Appl. No.: 10/567,267

(22) PCT Filed: Oct. 4, 2004
(86) PCT No.: PCT/GB2004/004211

§ 371 Date: Jun. 27, 2008

(51) Int. Cl. A62B 35/00; A41D 1/04

(52) U.S. Cl. 297/465; 2/102

(57) ABSTRACT

An improved vehicle safety device in the form of a garment wearable on the torso of a person. The garment has a body section having a front portion and a back portion, the front portion having one or more loops or straps to which a car seat belt can be attached. The device also incorporates quick release mechanisms to allow it to be quickly and securely attached to a person and to be quickly removed in case of an emergency.

The present invention relates to a vehicle safety device, suitable for improving the personal safety of a person in a vehicle.

Passenger safety requirements in vehicles have become more stringent and people in general have become more safety conscious. In most cases when transporting young people, particularly young children in cars, a separate seat is included to lift the child up above the level of the seat of the car.

Such devices come in two main types. Firstly, a car seat is provided for very young children. In the case of very young children, greater support is required and larger seats are provided. These car seats include a lower base portion and an upper portion which supports the back and neck of the child. The entire structure is designed to be placed on the existing back seat of the car and to be strapped in to the back seat using the existing seat belt.

Whilst such seats are ideal for extremely young children, they take up a large amount of space in the back seat of a car and where the child is old enough to sit up in the back seat of the car, this type of car seat can make it very difficult for others to use the back seat.

In addition, it is time consuming to install and remove car seats of this type. The need to install and remove car seats of this type is more pressing where alternative uses for the back seat of the car are routinely required.

Secondly, there is a ‘booster’ seat which is designed for use by older children and which consists of a seat base which is placed on the back seat of the car such that when the child sits on the seat base, they are lifted up to a level such that the seat belt provided in the car should hold the child at the level of the shoulders. Clearly, a belt that extended across the neck of a child could be extremely dangerous were the car to stop suddenly and instead of being an additional safety feature of the car, could possibly lead to injury or even strangulation.

In addition, many older children stop using booster seats before they are physically big enough to sit in the back seat of a car with the seat belt in the correct position. This also leads to a situation where the belt extends across the neck of the child.

It is an object of the present invention to provide an improved vehicle safety device that overcomes the above problems.

In accordance with a first aspect of the present invention there is provided a vehicle safety device wearable on the torso of a person, the device comprising: a body section having a front portion and a back portion, the front portion having attachment means adapted to receive a vehicle seat belt such that when worn, the seat belt can be removeably connected to the garment by the attachment means so as to secure the seat belt to the body of the garment.

Preferably, the attachment means comprises a releasable clip.

Preferably, the attachment means comprises a fabric strap removeably connected to the body of the device through eyelets formed in the body of the device.

Preferably, the attachment means is fixedly connected to the body of the device.

The attachment means may be stitched to the body of the device.

Preferably, the body of the device is made from fabric.

Optionally, the body of the device is made from strengthened synthetic fabric.

Preferably, the body of the device is sleeveless.

Preferably, the front portion of the body and the back portion of the body are formed in a single piece.

Preferably, the front portion of the body and the back portion of the body are fixedly connected at the shoulder only.

Preferably, the front portion and back portion of the device are removably attached down the side of the body of the device below the position of the arm holes by release means.

Preferably, the release means comprises a releasable clip.

Preferably, the release means comprises velcro™ which extends at least in part up the side of the device to the position below the position of the arm holes.

Preferably, the attachment means are provided on the device such that a seat belt can pass below the attachment means.

Preferably, a plurality of attachment means are positioned on the jacket to accommodate the diagonally extending strap of a seat belt.

Preferably, at least one attachment means is positioned at or near the shoulder of the body of the device so as to, in use, guide the diagonal strap of the belt away from the neck or face of the user.

Preferably, the device is a jacket, having a central zip or buttons for opening and closing the jacket.

The present invention will now be described by way of example only with reference to the accompanying drawings in which:

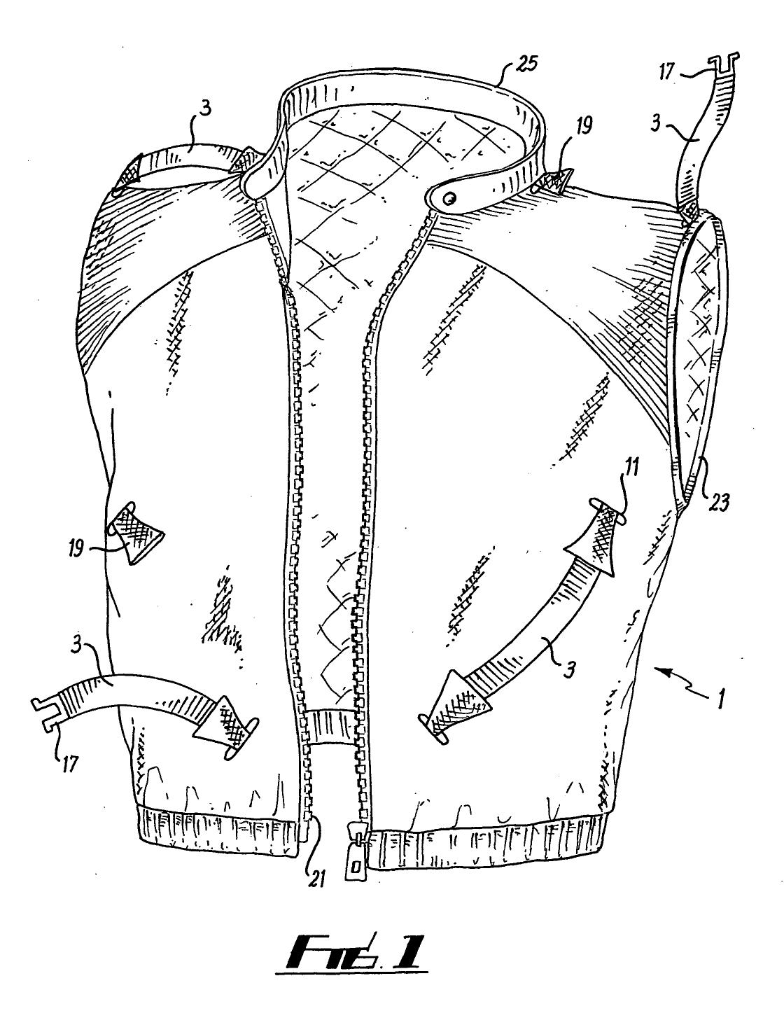

FIG. 1 shows a first embodiment of the present invention;

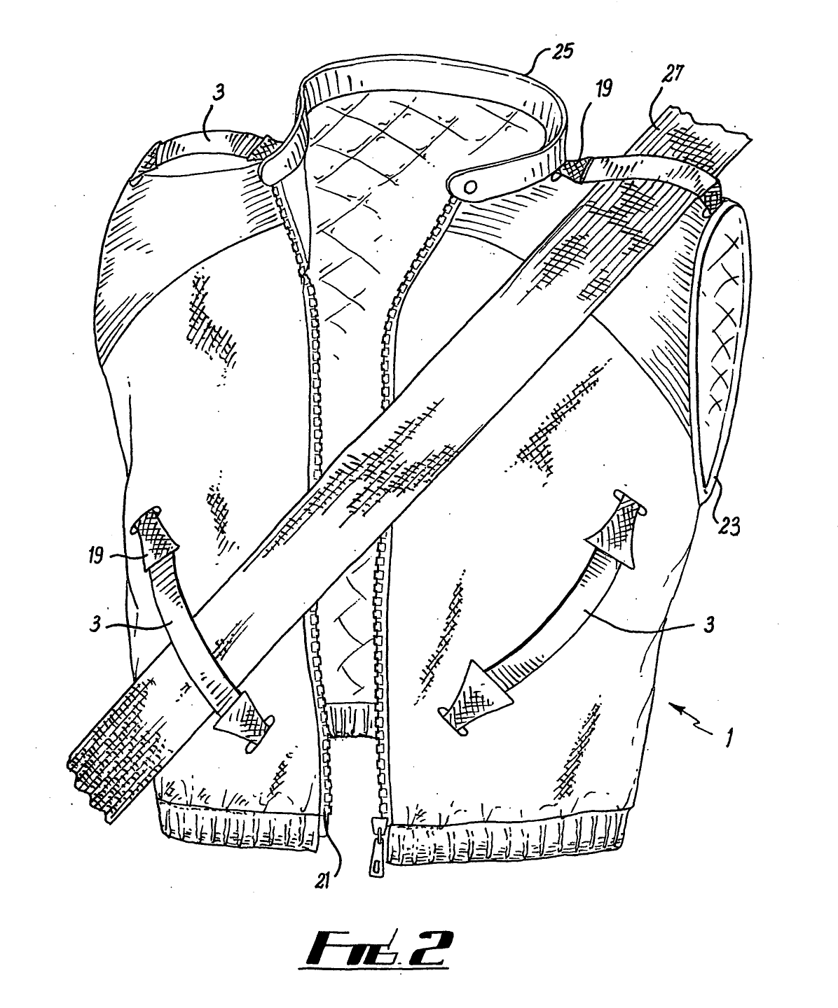

FIG. 2 shows the first embodiment of the present invention with a seat belt attached thereto;

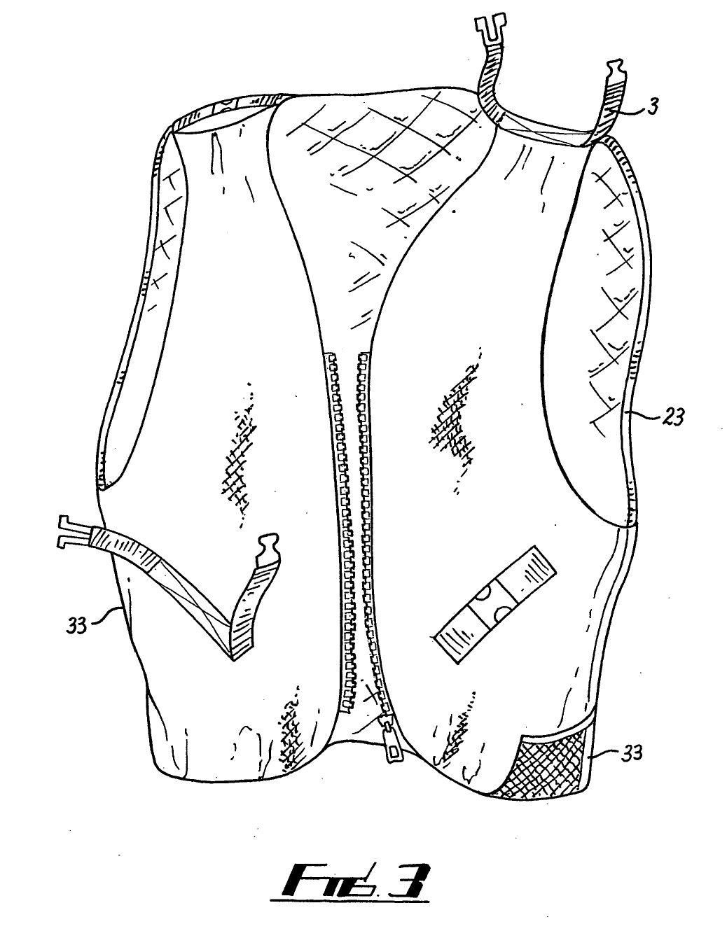

FIG. 3 shows a second embodiment of the present invention with a seat belt attached thereto;

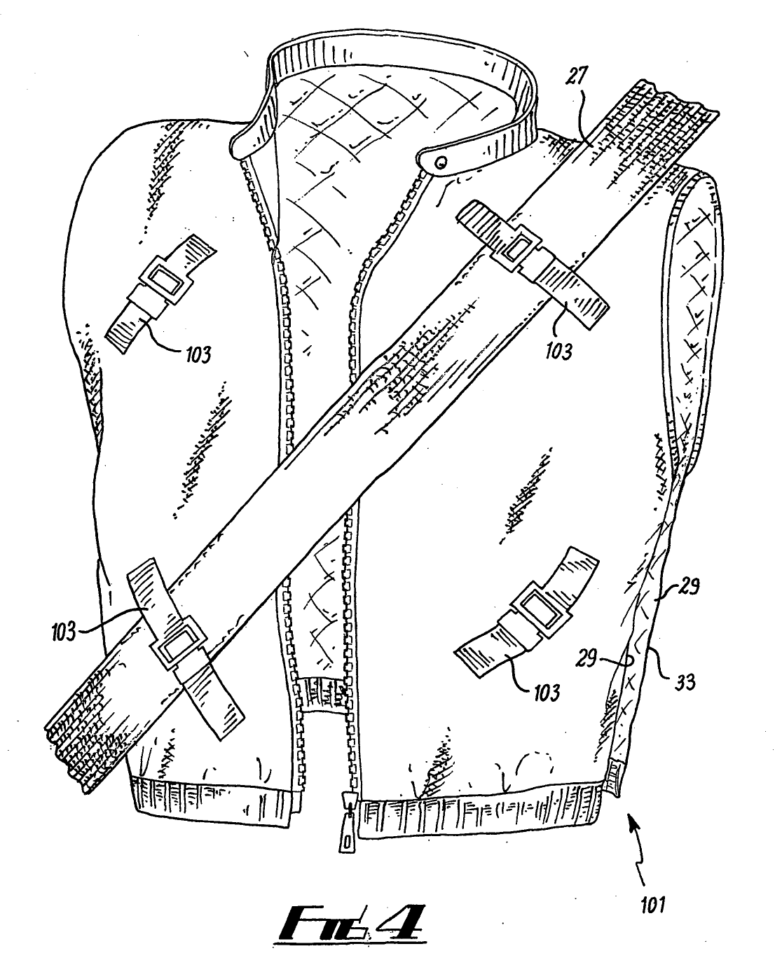

FIG. 4 shows a third embodiment of the present invention with a seat belt attached thereto; and

FIG. 5 shows a fourth embodiment of the present invention with a seat belt attached thereto.

FIG. 1 shows a garment or jacket 1 made from a strong, light weight material having attachment means formed by straps 3 located on the shoulder section of the jacket and across the body of the jacket on either side of the jacket. The attachment means 3 are positioned such that a seat belt can be threaded through the attachment means when in use. A zip 21 is provided for fastening the jacket at the front. Alternatively, buttons or any other suitable fastener might be used.

In this example, the attachment means comprise releasable clips with a male portion 17 and female portion 19. Releasable clips of this type are well known in the art. The attachment means 3 are connected to the jacket by means of eyelets 11 which are being cut through the fabric of the jacket and which have been strengthened by metal washers provided at the circumference of the eyelet 11.

Jackets containing eyelets 11 allow the straps 3 to be easily removed from the body of the jacket and allow the straps to be repositioned on the inside of the jacket in order to make the jacket reversible.

FIG. 2 shows the jacket 1 with the diagonally extending strap 27 of a seat belt attached to the jacket. As can be seen, the seat belt strap 27 is passed below each of the attachment means 3 and the attachment means 3 is clipped together using the connector 17 and 19 to prevent easy removal of the strap 27.

The provision of two attachment means 3, one at or near the shoulder of the jacket and one below and diagonally across the front of the jacket, provides two positions at which the diagonal strap of a seat belt is supported and attached to the jacket. This provides a more secure and stable attachment to the jacket than would be provided if the seat belt was connected to the jacket at a single position. The horizontal strap of the seat belt can sit over the jacket in the usual way.

FIG. 3 shows a second embodiment of the present invention substantially identical to the first embodiment except that the side of the jacket 33 is openable and is provided with Velcro™ sections connected to opposing surfaces of the front and back portions of the jacket at the open sides 33. As is apparent this jacket is sleeveless and providing open sides that extend from the bottom of the jacket to the arm holes 23 allows the jacket to be removed by detaching the Velcro™ pieces contained on opposing front and back portions of the jacket 33. This allows the jacket to be removed over the head of the user extremely easily in case of emergency in a single movement.

A further embodiment of the jacket has sleeves and is substantially identical to the jacket shown in FIG. 3 except that the lower half of the sleeve also includes a Velcro™ section to allow easy removal of the jacket.

Whilst Velcro™ is used in the above embodiments, other fastening means may be used which allow easy removal of the jacket in emergencies.

FIG. 4 shows a third embodiment of the present invention with attachment means 103, positioned diagonally across the jacket. In this example, a different releasable clip is used and the attachment means on the upper portions of the jacket are not situated on the shoulder itself, but below the shoulder. In some cases, it is more comfortable to have the seat belt attached below the shoulder. In addition, attachment means 103 are sown into the fabric of the jacket in this example.

The attachment means 3, 103 shown in FIGS. 1 to 5 function to be releasably attachable. Any type of attachment means that is releasably attachable would be suitable for use with the present invention. The attachment means may be a clip, lockable safety clip or buckle.

As in the previous embodiment of the present invention, the open sides of the jacket are provided with the attachment means which in this case are also constructed from Velcro™.

FIG. 5 shows a further embodiment of the present invention in which the attachment means at the open sides of the jacket are made using releasable clips. Other mechanisms may be used that allow quick release of the jacket in emergencies.

The invention may be designed to look like a football strip or incorporate a design associated with a cartoon character or the like so as to make the device more attractive to the wearer.

The present invention is intended for use by child passengers in a motor vehicle such as a car, a bus or the like. The invention is also suitable for use by handicapped or autistic people of any age or by those suffering from dementia.

The present invention is designed to function in place of a traditional car seat but advantageously, used up much less space in the rear of a car.

In addition, the jacket prevents rubbing or chaffing that can be caused when a seat belt “rides up” as occurs where a seat belt is used without the present invention.

Improvements and modifications may be incorporated herein without deviating from the scope of the invention.

1. A vehicle safety device wearable on the torso of a person, the device comprising:
a body having a front portion and a back portion, the front portion having attachment means adapted to receive a vehicle seat belt such that the seat belt can be removably connected to the garment by the attachment means so as to secure the seat belt to the body of the garment.

2. A device as claimed in claim 1, wherein the attachment means comprises a releasable clip.

3. A device as claimed in claim 1, further comprising eyelets formed in the body of the device and wherein the attachment means comprises a fabric strap removeably connected to the body of the device through the eyelets.

4. A device as claimed in claim 1, wherein the attachment means is fixedly connected to the body of the device.

5. A device as claimed in claim 1, wherein the body of the device is made from fabric.

6. A device as claimed in claim 1, wherein the body of the device is made from strengthened synthetic fabric.

7. A device as claimed in claim 1, wherein the body of the device is sleeveless.

8. A device as claimed in claim 1, wherein the front portion of the body and the back portion of the body are formed in a single piece.

9. A device as claimed in claim 1, wherein the front portion of the body and the back portion of the body are fixedly connected at a shoulder section only.

10. A device as claimed in claim 1:
further comprising a pair of arm holes; and
wherein the body has a side below each of the arm holes and the front portion and the back portion of the device are removably attached down the sides of the body by release means.

11. A device as claimed in claim 10, wherein the release means comprises a releasable clip.

12. A device as claimed in claim 10, wherein the release means comprise a hook and eye fastener which extends at least in part up each side of the body to a position below each of the arm holes.

13. A device as claimed in claim 1, wherein the attachment means are positioned on the device to accommodate a diagonally extending strap of the seat belt.

14. A device as claimed in claim 13, wherein:
the device further comprises a neck hole; and
at least one of the attachment means is positioned at or near a portion of the body of the device so as to guide the diagonally extending strap of the belt away from the neck hole or face of the person.
